(19) United States
(12) Patent Application Publication
(10) Pub. No.: US 2023/0391511 A1
(43) Pub. Date: Dec. 7, 2023

(54) FRONT PANEL OPENING POUCH ENCLOSURE AND METHODS OF MANUFACTURING THE SAME

(71) Applicant: Illinois Tool Works Inc., Glenview, IL (US)

(72) Inventor: Eric Plourde, Frankfort, IL (US)

(73) Assignee: Illinois Tool Works Inc., Glenview, IL (US)

(21) Appl. No.: 18/313,610

(22) Filed: May 8, 2023

Related U.S. Application Data
(60) Provisional application No. 63/349,817, filed on Jun. 7, 2022.

(51) Int. Cl. B65D 33/25; B31B 70/81; B31B 70/16

(52) U.S. Cl. CPC B65D 33/2533; B31B 70/8131; B65D 33/2583; B31B 70/16; B31B 2155/001

(57) ABSTRACT

A resealable front panel enclosure and method of manufacturing the same is provided that includes cutting or punching a tab in an unfolded film material and applying a zipper assembly to the film material. The film material is formed into a resealable enclosure by folding the film material subsequent to applying the zipper assembly to the film material. The tab is disposed on an exterior surface of a first side of the formed resealable enclosure, and the zipper assembly is disposed on an interior surface of the first side of the formed resealable enclosure.

### CROSS-REFERENCE TO RELATED APPLICATIONS

This application claims priority to U.S. Provisional Application No. 63/349,817, which was filed on Jun. 7, 2022. The entire disclosure of which is incorporated herein by reference.

### BACKGROUND

### Technical Field

The subject matter described herein relates to pouch assemblies that open on a front panel of the pouch assemblies and include a tear tape strip to access zipper assemblies of the pouch assemblies.

### Discussion of Art

Flexible enclosures can hold a variety of material. One example of a flexible enclosure is a pouch enclosure having an opening along a front panel of the enclosure. Some of these types of pouch enclosures have zipper assemblies that can resealably mesh and decouple from each other to close and open the pouch enclosures. A subset of these types of pouch enclosures are provided with the zipper assemblies sealed under the front panel of the enclosures. The zipper assemblies can be accessed by pulling on a tab connected with a tear tape strip coupled with an interior side of the front panel. Pulling on the tab tears the front panel along the tear tape strip and provides an opening through the front panel. Consumers can reach into these openings and pull apart the zipper assembly to access the product held inside the pouch enclosure.

It can be difficult to manufacture these types of enclosures. Specifically, the alignment of punches that cut through the panels of the enclosures to form the tabs may need to be carefully calibrated and maintained to ensure that the tab is properly formed and positioned.

It may be desirable to have a manufacturing process of these enclosures that differs from those that are currently available.

### BRIEF DESCRIPTION

In accordance with one example or aspect, a method is provided that includes cutting or punching a tab in an unfolded film material and applying a zipper assembly to the film material. The film material is formed into a resealable enclosure by folding the film material subsequent to applying the zipper assembly to the film material. The tab is disposed on an exterior surface of a first side of the formed resealable enclosure, and the zipper assembly is disposed on an interior surface of the first side of the formed resealable enclosure.

In accordance with one example or aspect, a resealable enclosure is provided that includes a body formed of a film material. The body includes a first side and a second side defining an interior cavity of the resealable enclosure. A tab is formed on an exterior surface of the first side of the enclosure. A zipper assembly may be coupled with an interior surface of the first side of the enclosure. The tab is cut or punched on the exterior surface of the first side of the body by separating the tab from an unfolded film material. The tab is cut completely through an entire thickness of the unfolded film material between the exterior surface and the interior surface of the first side of the enclosure prior to folding the film material to form the body. Cutting or punching the tab does not cut through the second side of the body.

In accordance with one example or aspect, a method is provided that includes cutting or punching a tab in an unfolded film material by completely cutting through an entire thickness of the unfolded film material between an exterior surface and an interior surface of the unfolded film material. A zipper assembly may be applied to the interior surface of the film material. A resealable enclosure may be formed with the film material by folding the film material subsequent to applying the zipper assembly to the interior surface of the film material.

### BRIEF DESCRIPTION OF THE DRAWINGS

The inventive subject matter may be understood from reading the following description of non-limiting embodiments, with reference to the attached drawings, wherein below:

FIG. 1 illustrates a front view of a formed resealable enclosure, according to an embodiment;

FIG. 2 illustrates a cross-sectional perspective view of the formed resealable enclosure shown in FIG. 1;

FIG. 3 illustrates a front view of the formed resealable enclosure;

FIG. 4 illustrates a cross-sectional side view of a formed resealable enclosure, according to an embodiment;

FIG. 5 illustrates a method of forming a resealable enclosure, according to an embodiment; and

FIG. 6 illustrates a perspective view of forming a resealable enclosure, according to an embodiment.

### DETAILED DESCRIPTION

One or more embodiments of the inventive subject matter described herein provide a front panel opening for a resealable enclosure and a method of manufacturing the same. The resealable enclosure may include a tab cut or punched into an unfolded film material, and a zipper assembly may be applied to the unfolded film material subsequent to the tab being cut or punched. The film material may be folded or manipulated to form the resealable enclosure or pouch that includes the tab positioned on a first side or front panel of the enclosure. Removing the tab and a portion of the film material from the front panel of the enclosure allows access to the zipper assembly.

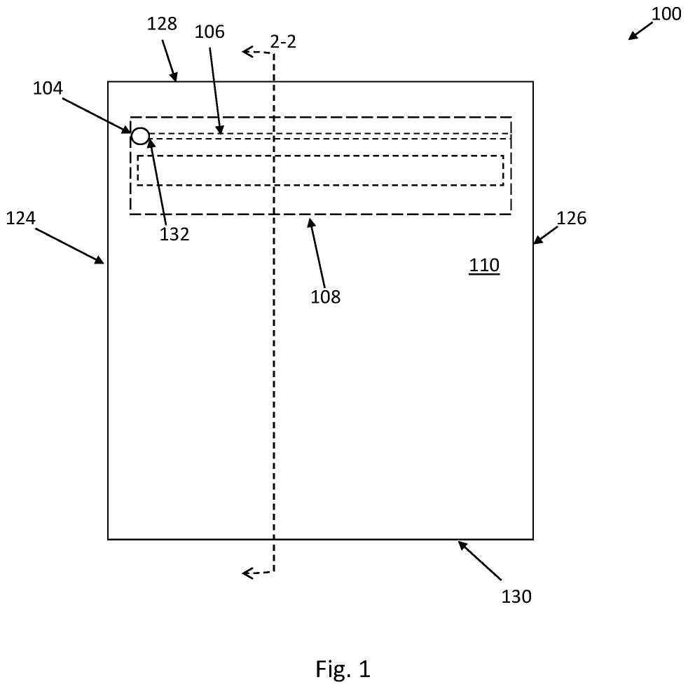

FIG. 1 illustrates a front view of one example of a resealable enclosure 100. The enclosure may be a flexible enclosure that includes one or more films formed in the shape of a bag. The enclosure may include an opening that may be accessible with the removal of a tab 104, such as by a consumer or user of the enclosure. In one or more embodiments, the enclosure may include one or more lines of weakness 106 that may be connected with the tab. For example, the one or more lines of weakness may tear away a portion of the film material from the enclosure responsive to the removal of the tab.

A zipper assembly 108 may be coupled with the film at or near the tab of the enclosure. The zipper assembly may attach to itself to allow a consumer to repeatedly open and close the enclosure 100, such as to access an interior cavity of the enclosure. In alternative embodiments, the enclosure may include a feature or design that is alternative to the zipper assembly that may be repeatedly opened and closed. For example, the zipper assembly may be or represent a mesh coupling design (e.g., hook and loop), or the like. In the illustrated embodiment, the tab is disposed within an area defined by the zipper assembly, but alternatively may be disposed away from the zipper assembly (e.g., closer to a top end 128 of the enclosure).

The zipper assembly and/or the film material of the enclosure may be formed from one or more polymers, and may include non-common materials. For example, a body of the zipper assembly may incorporate non-common materials, or a combination of non-common and common materials. The virgin material of the zipper assembly and/or the film material may be a polymer or other type of material that is not post-consumer recycled (PCR) material or post-consumer recyclate (e.g., virgin resin), is not HDPE, or is a material that is currently approved by the Food And Drug Administration (FDA) for contact with food.

Optionally, one or more regions or the entirety of components described as being formed from or including PCR material may instead be formed from or include other non-common materials. PCR material may be a non-common material, as are other non-food grade resins or non-FDA approved materials (e.g., PCR resins, HDPE resin, etc.). By encapsulating these materials within common materials or FDA approved materials (e.g., not PCR resins and/or not HDPE resin, such as polyethylene that is not HDPE), these non-common materials can be used in enclosures 100 that store or hold food without introducing risk to the consumer.

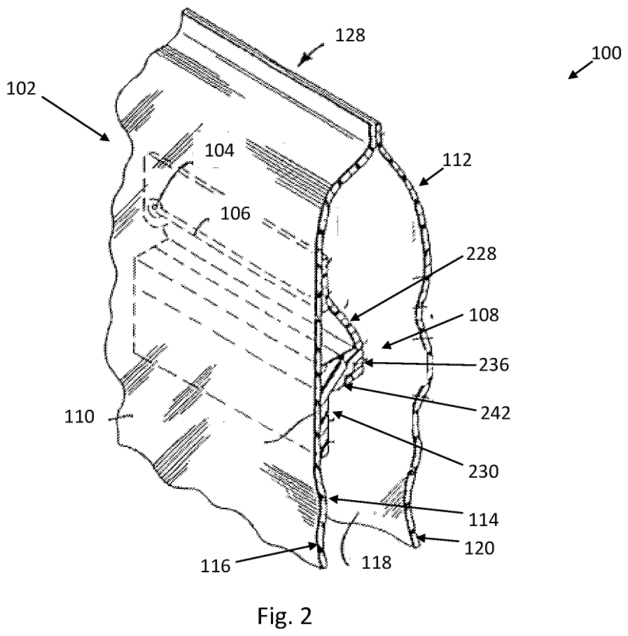

FIG. 2 illustrates a cross-sectional perspective view of the resealable enclosure shown in FIG. 1. The resealable enclosure includes a body 102 that is defined by a first side 110 and a second side 112 that is opposite the first side. In one or more embodiments, the first side may represent or be referred to as a front panel of the enclosure, and the second side may represent or be referred to as a rear panel of the enclosure. The first side includes an interior surface 114 and an exterior surface 116, and the second side includes an interior surface 118 and an exterior surface 120. The body has a width that extends between a first edge 124 and a second edge 126, and a length that extends between the top end 128 and a bottom end 130 (shown in FIG. 1).

In one or more embodiments, the enclosure may be formed by folding or otherwise forming an unfolded film material into the shape of the enclosure. Prior to folding or forming the enclosure, a tab 104 may be formed on the first side of the unfolded film material. Optionally, one or more lines of weakness 106 may be formed on the first side of the unfolded film material. In the illustrated embodiment of FIGS. 1 and 2, the enclosure includes at least two lines of weakness, but in alternative embodiments the enclosure may include any number of lines of weakness. Each line of weakness may be coupled with or connected to the tab at a connection point 132. The lines of weakness may be lines of perforations disposed along the first side of the enclosure. In one or more embodiments, the lines of weakness may be referred to as tear tape strips, perforated tear lines, score lines, or the like.

Additionally, a zipper assembly 108 may be applied to the interior surface 114 of the first side 110 of the unfolded film material. In the illustrated embodiment of FIG. 2, the zipper assembly includes a first profile strip 228 and a second profile strip 230. The first profile strip includes a groove portion 236 that corresponds with a protuberance portion 242 of the second profile strip. The first and second profile strips are coupled with the interior surface of the first side of the unfolded film material.

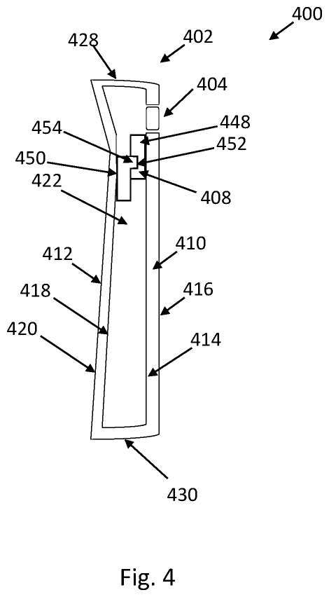

Optionally, one of the profile strips may be coupled with one interior surface of the formed enclosure, and another profile strip may be coupled with another interior surface of the formed enclosure. For example, FIG. 4 illustrates a side cross-sectional view of a formed resealable enclosure 400 in accordance with an embodiment. The formed enclosure extends between a top end 428 and a bottom end 430, and a first side 410 and an opposite second side 412. A tab 404 is formed on the first side of the unfolded film material. Optionally, one or more lines of weakness may be connected with the tab.

In one embodiment, a first profile strip 448 of a zipper assembly may be coupled with the unfolded material at a first location, and a second profile strip 450 may be coupled with the unfolded material at a second location that aligns with the first profile strip when the unfolded material has been formed into the formed enclosure. The first profile strip may include a groove 452 that corresponds to a protuberance 454 of the second profile strip.

In another embodiment, the zipper assembly 408 may be applied to an interior surface 414 of the first side of the unfolded film material. For example, subsequent to the unfolded film material being folded or formed into the enclosure, an interior surface of the second side of the enclosure may be coupled with the zipper assembly, such as by adhesion, applying thermal energy to the enclosure proximate to the zipper assembly, or the like. For example, in the formed resealable enclosure, the first profile strip 448 of the zipper assembly may be coupled with the interior surface of the first side of the body and the second profile strip 450 may be coupled with the interior surface of the second side of the body. Optionally, the resealable enclosure may have an alternative type and/or style of a zipper assembly, and the zipper assembly may be positioned in alternative locations relative to the tab.

In one or more embodiments, the unfolded film material, including the tab, the zipper assembly coupled or otherwise formed therewith, may be folded or otherwise formed into the body of the resealable enclosure. For example, the film material may be folded or formed into the enclosure subsequent to the tab, the lines of weakness, and the zipper assembly being formed and/or coupled with the unfolded film material. In the illustrated embodiment, the two lines of weakness traverse a distance that is about the width of the resealable enclosure between the first and second edges. In one or more embodiments, the lines of weakness traverse at least a portion of a distance of the width of the enclosure that is at least a width of the zipper assembly between the first and second edges. For example, the lines of weakness extend a distance that is at least the same or greater than a distance that the zipper assembly extends along the width of the enclosure. Optionally, the lines of weakness may traverse a distance that is less than a length or distance of the zipper assembly.

Returning to the embodiment illustrated in FIGS. 1 and 2, the first and second sides, the first and second edges, and the top and bottom ends of the body define an interior cavity 122 of the resealable enclosure. The interior cavity may be accessible responsive to the removal of the tab and the lines of weakness from the first side of the enclosure, such as by the consumer pulling the tab and the lines of weakness away from the first side of the enclosure. Removing the tab and the lines of weakness exposes or allows access to the zipper assembly, which may be repeatedly opened and closed to access the interior cavity. In the illustrated embodiment, the zipper assembly includes groove and protuberance locking elements, but alternatively, the first and second profile strips may include any alternative locking elements that may mate with each other to close the zipper assembly 108 (and enclosure 100). The locking elements may be pulled apart (e.g., by a consumer pulling on opposite sides lines of weakness) to open the enclosure 100.

In one or more embodiments, the tab (and optionally the lines of weakness) may be formed into the first side of the unfolded film material by cutting, punching, or otherwise puncturing the unfolded film material. The tab may be formed by puncturing the tab completely through an entire thickness of the film material to separate the tab from the film material. For example, in the illustrated embodiment of FIG. 2, the tab is separated from the first side of the film material of the enclosure such that the tab is punctured through an entire thickness of the film material between the interior and exterior surfaces of the first side. For example, a space or void is disposed between the tab and the film material of the first side of the enclosure.

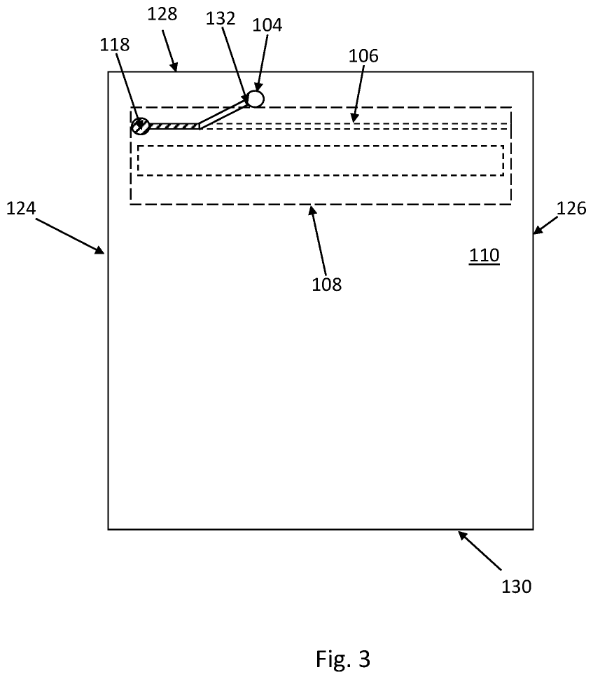

In one or more embodiments, the lines of weakness may be formed into the first side by partially cutting or punching the film material. For example, in the illustrated embodiment of FIG. 3, the two lines of weakness are punctured only partially through the thickness of the film material between the interior and exterior surfaces of the first side of the enclosure. For example, the lines of weakness may be perforated such that a portion of each line of weakness may be cut or separated from the film material, and another portion of each line may remain coupled with the film material. In one or more embodiments, cutting or punching the tab and the lines of weakness includes separating the tab from the film material, and partially separating the lines of weakness from the film material. For example, the tab and the lines of weakness may be cut or punched so that the tab and the lines of weakness may be removed from the first side of the formed enclosure by a consumer to access the zipper assembly.

FIG. 3 illustrates a front view of the formed enclosure with the tab and a portion of the lines of weakness partially removed from the first side of the enclosure. For example, a consumer may grab the tab and pull the tab away from the first side of the enclosure. The lines of weakness, connected with the tab at the connection point 132, may be removed or separated from the first side of the enclosure responsive to the tab being pulled away from the first side of the enclosure. In one or more embodiments, removing the tab and the lines of weakness from the first side of the formed enclosure exposes a portion of the interior surface of the second side of the resealable enclosure that is opposite the tab and the lines of weakness. For example, removing the tab and the lines of weakness leaves an opening, a passage, a hole, or the like, in the first side of the enclosure, and allows a consumer to access the zipper assembly disposed on the interior surface of the enclosure. Optionally, the tab may be positioned within an area defined by the zipper assembly, such that removing the tab exposes a portion of the first profile strip 228 of the zipper assembly, and allows the consumer to access the locking elements of the zipper assembly. Optionally, the tab and the lines of weakness may be cut or punched in the unfolded film material such that the removed tab and lines of weakness may be permanently separated from the enclosure. For example, the tab and the lines of weakness may be prohibited from being re-attached to the first side of the enclosure. In another embodiment, the tab (and optionally the lines of weakness) may be formed into the unfolded film material such that the tab and portion of the film material may be capable of being re-attached to the first side of the enclosure (e.g., via an adhesive coupling element, another zipper element, locking elements, or the like).

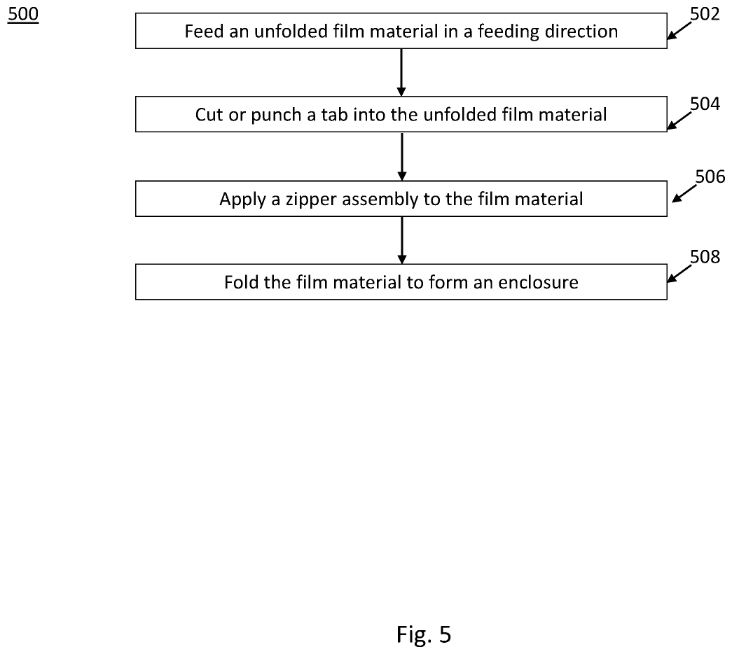

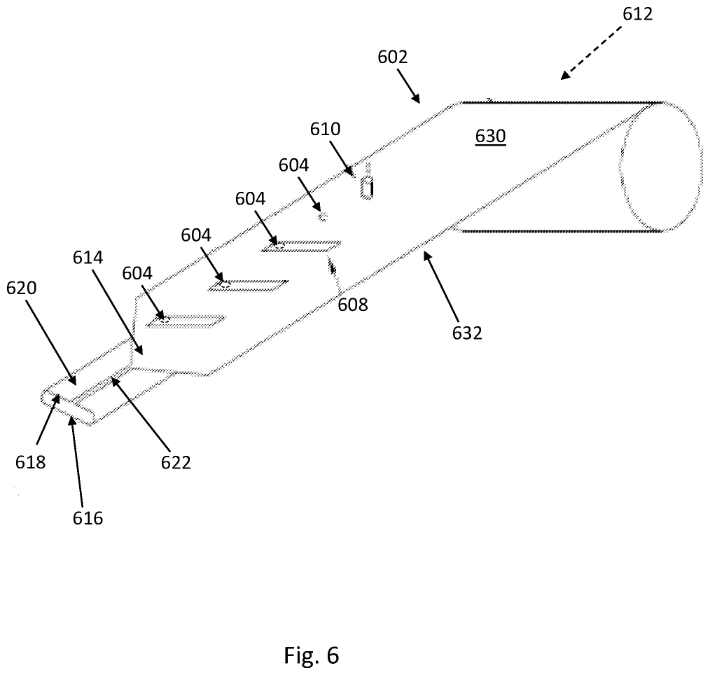

FIG. 5 illustrates a method 500 of forming a resealable enclosure, according to an embodiment. FIG. 6 illustrates a perspective view of forming the resealable enclosure, according to an embodiment. FIGS. 5 and 6 will be discussed together herein. At 502, an unfolded film material 602 is fed in a feeding direction 612. For example, the unfolded film material is fed or advanced in the feeding direction toward one or more processing steps to form the resealable enclosure, such as with a form-fill-seal (FFS) machine or system. In the illustrated embodiment of FIG. 6, the unfolded film material is fed from a spool or roll stock of the unfolded film material in the feeding direction, such as toward forming, cutting, or punching machines or devices. The unfolded film material includes a first surface 630 and an opposite second surface 632.

At 504, a tab 604 may be cut or punched into the unfolded film material. For example, as shown in FIG. 6, a punch device 610 may punch or cut the tab through the entire thickness of the unfolded film material from the second surface 632 and through the thickness of the film material to the first surface 630. Optionally, the punch device, or another punching or cutting device, may cut one or more lines of weakness, connected with the tab, only partially through the thickness of the unfolded film material from the second surface 632. For example, the punching or cutting device used to punch or cut the lines of weakness may form perforations on the second surface 632 of the unfolded film material. In one or more embodiments, the tab and the lines of weakness may be cut or punched in the same processing step or at substantially the same time. In another embodiment, the tab may be cut or punched at a first stage of the processing of the film material, and the film material may be fed or advanced to another stage of the processing system to cut or punch the line(s) of weakness. The one or more lines of weakness may extend in a direction that is substantially perpendicular to the feeding direction 612 of the unfolded film material. In one or more embodiments, some portions of the lines of weakness may be cut through the thickness of the unfolded film material, and other portions of the lines of weakness may not be cut, may be cut partially through the thickness, or the like.

At 506, a zipper assembly 608 is applied to the first surface 630 of the unfolded film material. In the illustrated embodiment, the zipper assembly is positioned such that the zipper assembly overlays or is disposed on top of or over the cut tab (and optionally the one or more lines of weakness). For example, positioning the zipper assembly on top of the tab hides the tab from view from the first surface of the unfolded film material. Optionally, the zipper assembly may be positioned such that the zipper assembly is disposed on top of or overlays only a portion of the tab, or such that the zipper assembly is separated from the tab (e.g., the tab is visible from the first surface of the unfolded film material). In one embodiment, the zipper assembly may be coupled with the unfolded film material via an adhesion, via thermal energy application (e.g., a heat source may direct thermal energy toward the zipper assembly positioned on the film material to heat seal the zipper assembly to the film material), or the like. In one or more embodiments, the lines of weakness or tear strips may be incorporated with the zipper assembly. For example, the tear strips or lines of weakness may be integrated or incorporated with the first profile strip that is disposed overtop of the cut tab and extends a portion of a width of the film material.

At 508, the unfolded film material is folded or otherwise manipulated to form the formed resealable enclosure. In the illustrated embodiment of FIG. 6, the film material is folded such that the second surface of the unfolded film material wraps partially around the first surface of the unfolded film material and toward a seam 622 at a junction of the folded film material. In one or more embodiments, edges of the unfolded film material may be bonded or otherwise coupled together at the seam, such as by applying thermal energy, via adhesion, or any alternative coupling method.

Wrapping the film material forms the interior cavity of the body of the enclosure. For example, a portion of the first surface 630 may become an interior surface 614 of a first side of the formed enclosure, and another portion of the first surface 630 may become an interior surface 618 of a second side of the formed enclosure. Additionally, a portion of the second surface 632 may become an exterior surface 616 of the first side of the formed enclosure, and another portion of the second surface may become an exterior surface 620 of the second side of the formed enclosure. The top and bottom ends of the enclosure (e.g., shown in FIG. 1) may be formed by applying thermal energy to portions of the folded film material to heat seal the film material.

The tab (and optionally the lines of weakness) are cut or punched into the unfolded film material, and the film material is folded or manipulated subsequent to the punching or cutting of the tab and the lines of weakness (e.g., at a location that is downstream of the cutting and punching positions). By cutting or punching the tab and lines of weakness prior to applying the zipper assembly and forming the resealable enclosure, the cutting or punching devices do not cut through, puncture, or otherwise come into contact with the zipper assembly or the second side of the formed resealable enclosure. For example, the zipper assembly and the second side of the formed enclosure are devoid any cuts, marks, indents, divots, or the like, such as from the cutting or punching devices used to cut or punch the tab and lines of weakness. Because the zipper assembly is attached to the unfolded film material and the enclosure is formed after or subsequent to the punching or cutting of the tab and lines of weakness, the tab may be cut entirely through the thickness of the film material and the lines of weakness may be partially cut through the thickness of the film material without the second side of the enclosure disposed behind or on the other side of the first side of the enclosure and being exposed to the cutting or punching devices. Alternatively, applying the zipper assembly and/or forming the enclosure, and then subsequently cutting or punching the tab and/or lines of weakness may subject the second side of the enclosure to cuts, punches, punctures, marks, or the like, on the second side of the formed enclosure, in one or more components of the zipper material, or the like.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
cutting or punching a tab in an unfolded film material;
applying a zipper assembly to the film material; and
forming a resealable enclosure with the film material by folding the film material subsequent to applying the zipper assembly to the film material, wherein the tab is disposed on an exterior surface of a first side of the formed resealable enclosure, and the zipper assembly is disposed on an interior surface of the first side of the formed resealable enclosure.

2. The method of claim 1, wherein cutting or punching the tab includes puncturing the tab completely through an entire thickness of the film material to separate the tab from the film material.

3. The method of claim 1, further comprising cutting or punching at least two lines of weakness connected with the tab partially through a thickness of the unfolded film material.

4. The method of claim 1, wherein cutting or punching the tab includes separating the tab from the film material.

5. The method of claim 1, wherein cutting or punching the tab does not cut through a second side of the resealable enclosure.

6. The method of claim 1, wherein the tab is cut or punched so that the tab and a portion of the film material connected with the tab are configured to be removed from the first side of the formed resealable enclosure by a consumer to access the zipper assembly.

7. The method of claim 6, wherein the tab that is cut or punched is configured to expose the zipper assembly responsive to the tab and the portion of the film material connected with the tab being removed from the first side of the body by the consumer.

8. The method of claim 1, wherein cutting or punching the tab includes puncturing a portion of the film material.

9. The method of claim 1, wherein the formed resealable enclosure is a flexible enclosure comprising the tab and the zipper assembly.

10. The method of claim 1, further comprising applying the zipper assembly to a portion of the interior surface of the first side of the formed enclosure that is opposite the tab that is disposed on the exterior surface of the first side of the formed enclosure.

11. A resealable enclosure comprising:
a body formed of a film material, the body including a first side and a second side defining an interior cavity of the resealable enclosure;
a tab formed on an exterior surface of the first side of the enclosure; and
a zipper assembly coupled with an interior surface of the first side of the enclosure,
wherein the tab is cut or punched on the exterior surface of the first side of the body by separating the tab from an unfolded film material, wherein the tab is cut completely through an entire thickness of the unfolded film material between the exterior surface and the interior surface of the first side of the enclosure prior to folding the film material to form the body,
and
wherein cutting or punching the tab does not cut through the second side of the body.

12. The resealable enclosure of claim 11, wherein the tab is cut or punched so that the tab and a portion of the film material connected with the tab are configured to be removed from the first side of the body by a consumer to access the zipper assembly.

13. The resealable enclosure of claim 12, wherein the tab that is cut or punched is configured to expose the zipper assembly responsive to the tab and the portion of the film material connected with the tab being removed from the first side of the body by the consumer.

14. The resealable enclosure of claim 11, wherein the zipper assembly is coupled with the interior surface of the first side of the enclosure subsequent to the tab being cut or punched on the exterior surface of the first side of the film material.

15. The resealable enclosure of claim 11, wherein the zipper assembly is configured to be coupled with a portion of the interior surface of the first side of the enclosure that is opposite the tab that is formed on the exterior surface of the first side of the formed enclosure.

16. A method comprising:
cutting or punching a tab in an unfolded film material by completely cutting through an entire thickness of the unfolded film material between an exterior surface and an interior surface of the unfolded film material;
applying a zipper assembly to the interior surface of the film material; and
forming a resealable enclosure with the film material by folding the film material subsequent to applying the zipper assembly to the interior surface of the film material.

17. The method of claim 16. wherein cutting or punching the tab does not cut through a second side of the formed resealable enclosure.

18. The method of claim 16, wherein the tab is cut or punched so that the tab and a portion of the film material connected with the tab are configured to be removed from a first side of the formed resealable enclosure by a consumer to access the zipper assembly.

19. The method of claim 18, wherein the tab that is cut or punched is configured to expose the zipper assembly responsive to the tab and the portion of the film material connected with the tab being removed by the consumer.

20. The method of claim 16, further comprising applying the zipper assembly to a portion of the interior surface of the unfolded film material that is opposite the tab that is disposed on the exterior surface of the unfolded film material.
